(19) United States
(12) Patent Application Publication
(10) Pub. No.: US 2021/0105956 A1
(43) Pub. Date: Apr. 15, 2021

(54) Spent Coffee Grounds-Infused Weed Barrier Mat and Method of Manufacturing Thereof

(71) Applicant: Robin Langguth, Oswego, IL (US)

(72) Inventor: Robin Langguth, Oswego, IL (US)

(21) Appl. No.: 17/066,413

(22) Filed: Oct. 8, 2020

Related U.S. Application Data
(60) Provisional application No. 62/912,983, filed on Oct. 9, 2019.

(51) Int. Cl. A01G 13/02; B31D 1/00; A01N 25/08; A01N 65/08

(52) U.S. Cl. CPC A01G 13/0268; A01N 65/08; A01N 25/08; B31D 1/00

(57) ABSTRACT

A novel spent coffee grounds (SPG)-infused weed barrier mat and a method of manufacturing the novel mat are disclosed. Compared to conventional methods of weed growth inhibitions using chemicals or paper mulches, the SPG-infused weed barrier mat is more durable, hydro-absorbent, and easily-divisible to protect and promote a garden's aesthetics, soil quality, and ecosystem, while acting as an effective smothering barrier against weed growth. Preferably, the SPG-infused weed barrier mat is formed by a plurality of detachable single modular mat units of standardized dimensions to accommodate dynamic and scalable sizing of the effective weed barrier mat area based on a user's particular gardening needs and requirements. Each single modular mat unit can be attached to or detached from each other to constitute a tiled arrangement of varying sizes. The SPG may be finely-milled coffee flours further processed from coarser SCGs for enhanced durability and maintenance of weed barrier mat-producing equipment.

### BACKGROUND OF THE INVENTION

The present invention generally relates to garden care and weed reduction tools and methods. More specifically, the present invention relates to an environmentally-friendly novel weed barrier mat. In addition, the present invention also relates to manufacturing the environmentally-friendly novel weed barrier mat cost effectively.

Conventional weed reduction or elimination methods for garden care typically involve periodic applications of weed-killing chemicals or utilizing a thick mulch in an attempt to smother potential weed growth. Because weed-killing chemicals often contain harmful substances to desirable plants, flowers, and humans, a growing number of gardeners, landscapers, and botanists is attempting to utilize more environmentally-friendly methods of weed control.

Unfortunately, conventional mulches made of wood chips, decaying leaves, and composts have limited effect in reducing future weed growth, as typical mulch layers do not remain thick enough and also lacks sufficient hydro-absorbent characteristics to stop potential weed growth by smothering over an extended period. Some people in the gardening community have experimented with placing cardboard layers underneath a mulch layer to make weed smothering more effective by maintaining the thickness and the moisture-absorbent characteristics of the combined cardboard and mulch layers.

However, utilizing cardboard layers derived from cardboard boxes often include glue residues or other sticky substances, which are significantly harmful to the topsoil and the existing ecosystem of desirable worms or other insects in a garden. Furthermore, even if the glue residues or other sticky substances are removed from the cardboard layers prior to placement in the garden, the utilization of the conventional cardboard layers over an extended period often leaves unsightly mucks in conspicuous colors as they decay, which become visible on the topsoil or through the mulch layer.

Therefore, it may be advantageous to devise a durable and easily-divisible novel weed barrier mat that does not harm a garden's aesthetics, soil quality, and ecosystem.

Furthermore, it may also be advantageous to devise an environmentally-friendly novel weed barrier mat that can be manufactured cost effectively.

In addition, it may also be advantageous to devise a method of manufacturing the durable and easily-divisible novel weed barrier mat that does not harm the garden's aesthetics, soil quality, and ecosystem.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a method for producing a spent coffee grounds (SCG)-infused modular weed barrier mat is disclosed. This method comprises the steps of: (1) acquiring a bundle of recycled paper with minimal or no glue residues and other sticky substances; (2) shredding the bundle of recycled paper to produce shredded papers; (3) hydrating the shredded papers to absorb water to produce hydrated and shredded papers; (4) agitating the hydrated and shredded papers to isolate and raise sticky and inky substances to a top surface, which in turn forms a top impurities layer from the hydrated and shredded papers; (5) removing the top impurities layer from the hydrated and shredded papers; (6) producing a pulp from the hydrated and shredded papers after removing the top impurities layer; (7) adding non-molded spent coffee grounds (SCG) to the pulp to produce a fresh SCG-infused pulp; (8) placing the fresh SCG-infused pulp on a rolling screen and extracting water and moisture from the fresh SCG-infused pulp; (9) dehydrating the fresh SCG-infused pulp by air drying or another dehydration process to produce a sheet of the fresh SCG-infused pulp; (10) flattening the sheet to a desirable thickness and cut to produce a flattened sheet of the fresh SCG-infused pulp; and (11) packaging the flattened sheet in modularly-attachable dimensions as the SCG-infused modular weed barrier mat.

In another embodiment of the invention, a spent coffee grounds (SCG)-infused modular weed barrier mat is disclosed. This SCG-infused modular weed barrier mat comprises: (1) a bundle of recycled paper with minimal or no glue residues and other sticky substances, wherein the bundle of recycled paper is transformed into a pulp after shredding, hydration, and removal of a top impurities layer; and (2) non-molded spent coffee grounds (SCG) added to the pulp to form a fresh SCG-infused pulp, which is subsequently placed on a rolling screen, dehydrated, flattened, and cut to be transformed into a flattened sheet of the fresh SCG-infused pulp, wherein the flattened sheet is then packaged in modularly-attachable dimensions as a SCG-infused modular weed barrier mat.

### BRIEF DESCRIPTION OF DRAWINGS

FIG. 1 shows a frontal view of a spent coffee grounds-infused weed barrier mat, in accordance with an embodiment of the invention.

FIG. 2 shows a backside view of a spent coffee grounds-infused weed barrier mat, in accordance with an embodiment of the invention.

FIG. 3 shows a tile arrangement of spent coffee grounds-infused weed barrier mats, in accordance with an embodiment of the invention.

FIG. 4 shows a tile arrangement of spent coffee grounds-infused weed barrier mats covered by a mulch layer, in accordance with an embodiment of the invention.

FIG. 5 shows an example of a garden incorporating the spent coffee grounds-infused weed barrier mats underneath the mulch layer, in accordance with an embodiment of the invention.

FIG. 6 shows an example of a manufacturing process for a spent coffee grounds-infused weed barrier mat, in accordance with an embodiment of the invention.

FIG. 7 shows a top view of a single modular mat unit for a tile arrangement of spent coffee grounds-infused weed barrier mats, in accordance with an embodiment of the invention.

FIG. 8 shows a bottom view of a single modular mat unit for a tile arrangement of spent coffee grounds-infused weed barrier mats, in accordance with an embodiment of the invention.

FIG. 9 shows a top view of a tile arrangement of modular mat units providing desirable dimension scalability for spent coffee grounds-infused weed barrier mats, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble spent coffee grounds-infused weed barrier mats and methods of producing such mats. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention does not inherently indicate any particular order nor imply any limitations in the invention.

For the purpose of describing the invention, a term referred to as “spent coffee grounds” is defined as milled coffee bean particles that have been utilized in extraction of coffee drinks. Typically, the spent coffee grounds can be acquired cheaply or even free of charge from coffee shops and restaurants, thus making them an environmentally-friendly and inexpensive choice as a potential feedstock for garden care products. Furthermore, the term “spent coffee grounds” in context of the present invention also includes and refers to very finely-powdered “coffee flours,” which may be products of additional milling and/or processing of previously-ground coarser coffee bean particles.

In one embodiment of the invention, a measured amount of spent coffee grounds is injected into a recycled paper pulp to produce a spent coffee grounds-infused weed barrier mat. In one example, a mixture ratio between the spent coffee grounds and the recycled paper pulp may be 1 to 8 in volume or weight (e.g. ⅛^{th} cubic inch of spent coffee grounds for every cubic inch of recycled paper pulp, 1 oz of spent coffee grounds for every 8 oz of the recycled paper pulp, etc.).

In addition, for the purpose of describing the invention, a term referred to as “mulch” is defined as one or materials acting as a top protective or covering layer in gardening. Typically, mulch is made of wooden chips, decaying leaves, straws, composts, other materials, or a combination thereof to reduce moisture evaporations, soil erosions, extreme temperature fluctuations, or weed proliferations, while promoting growths of plants, trees, or flowers that are surrounded by the mulch layer in a garden.

Furthermore, for the purpose of describing the invention, a term referred to as “pulp” is defined as a soft moist mass of matter made of recycled papers, cellulose, or other recycled materials that can be transformed into solid pieces of sheets, if dehydrated by air or other drying methods.

One aspect of an embodiment of the present invention is providing a durable and easily-divisible novel weed barrier mat incorporating spent coffee grounds to protect and promote a garden's aesthetics, soil quality, and ecosystem, while acting as an effective smothering barrier against weed growth.

Another aspect of an embodiment of the present invention is providing an environmentally-friendly and cost-effective novel weed barrier mat that utilizes inexpensive recycled materials and compounds.

Yet another aspect of an embodiment of the present invention is providing a method of manufacturing the durable and easily-divisible novel weed barrier mat that does not harm the garden's aesthetics, soil quality, and ecosystem, while acting as an effective smothering barrier against weed growth.

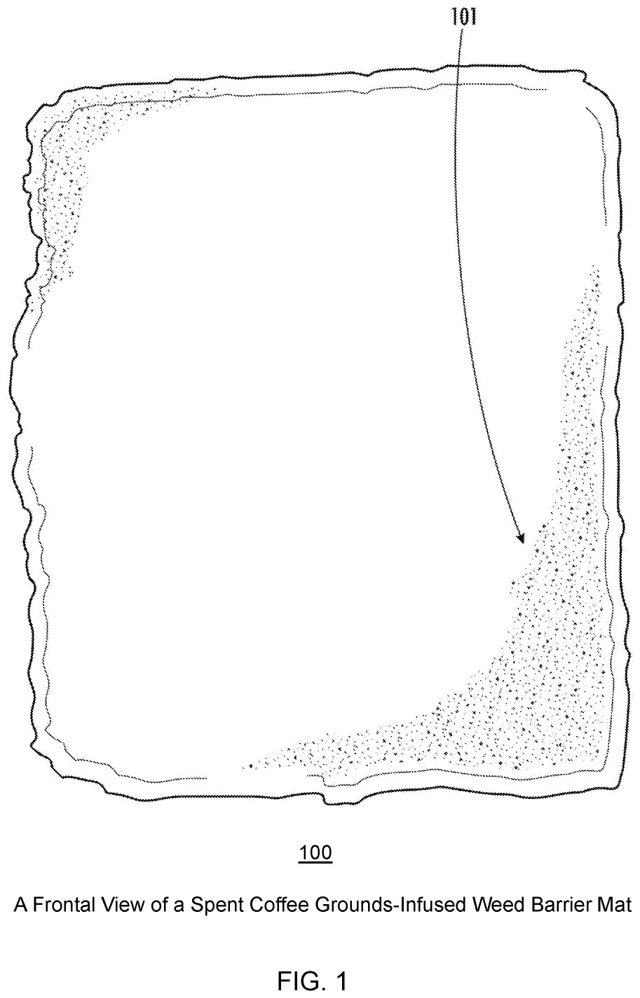

FIG. 1 shows a frontal view (100) of a spent coffee grounds-infused weed barrier mat (101), in accordance with an embodiment of the invention. The spent coffee grounds-infused weed barrier mat (101) comprises a solidified sheet made of dried pulp, which includes recycled papers and spent coffee grounds. In a preferred embodiment of the invention, newsprints, slick pieces of mailers, light cardboards, and other recycled cellulose materials can be shredded, hydrated, and mechanically agitated to be transformed into a pulp, which is a soft and moist mass of matter made of recycled papers.

Once the pulp is produced, preferably through a highly-scalable manufacturing process for production and cost efficiencies, a measured amount of spent coffee grounds (SCG) is added into the liquid pulp solution to synthesize a spent coffee grounds-infused pulp. In the preferred embodiment of the invention, the mixture ratio of SCG to the liquid pulp solution is 1 to 8 in volume or weight. In one example, one ounce of SCG may be added into eight ounces of the liquid pulp solution to create a spent coffee grounds-infused pulp. In another example, one cubic inch of SCG may be added into 8 cubic inch-worth of the liquid pulp solution to generate a spent coffee grounds-infused pulp.

In a subsequent manufacturing process, the spent coffee grounds-infused pulp undergoes a dehydration process via air drying or another drying method to produce a solidified sheet of dried spent coffee grounds-infused pulp. In one embodiment of the invention, the solidified sheet may be compressed by a stamping machine to conform to a desirable thickness, and may also be cut by a cutter machine to prespecified shapes and dimensions. Preferably, the fully-processed solidified sheet made of dried spent coffee grounds-infused pulp is sufficiently thick enough to smother weeds and durable enough to withstand multiple seasons of utilization as a weed barrier mat underneath a mulch layer in a garden.

As shown in FIG. 1, the spent coffee grounds-infused weed barrier mat (101) is produced by cutting and/or compressing the solidified sheet of dried spent coffee-infused pulp. By incorporating the spent coffee grounds in 1 to 8 ratio or in another calculated ratio with a pulp made of recycled papers, the spent coffee grounds tend to soften the pulp and add aesthetically-desirable and lasting rich brown coffee tones to the weed barrier mat, even after multiple rounds of rain, changing seasons, and temperatures. Furthermore, the spent coffee grounds in the spent coffee grounds-infused weed barrier mat (101) provide an additional benefit of adding nitrogen to enrich the soil in the garden as they decompose.

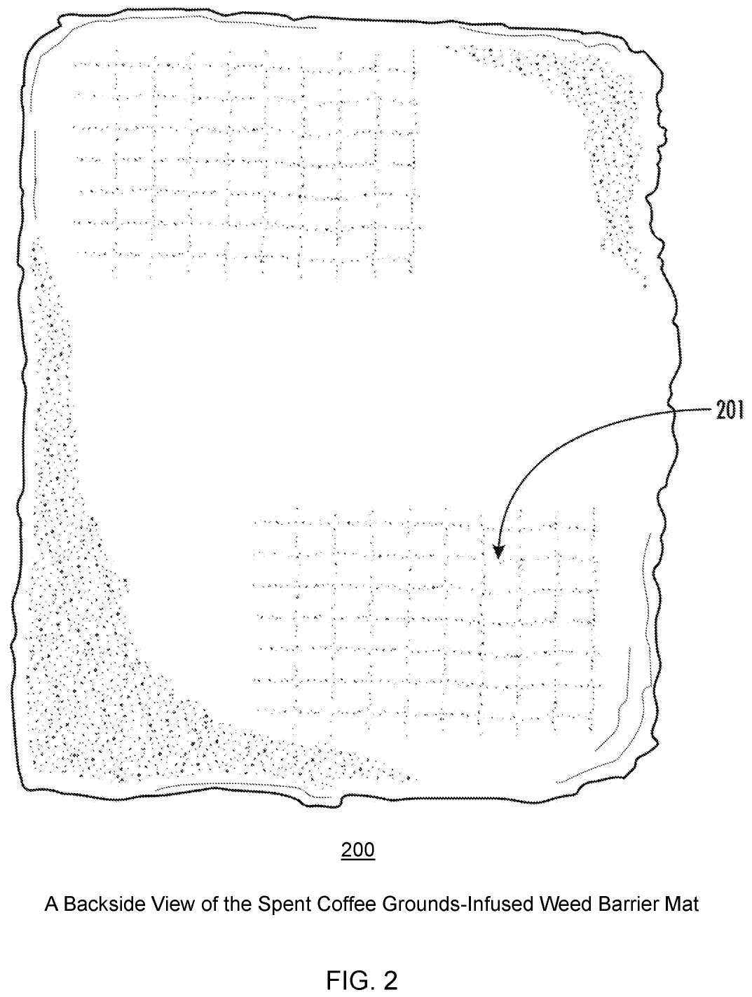

FIG. 2 shows a backside view (200) of a spent coffee grounds-infused weed barrier mat (201), in accordance with an embodiment of the invention. As illustrated in FIG. 2, the backside view (200) of the spent coffee grounds-infused weed barrier mat (201) shows particles of spent coffee grounds which are embedded into the dried spent coffee-infused pulp. In one embodiment of the invention, the backside view (200) of the spent coffee grounds-infused weed barrier mat (201) may also show screen marks, if the pulp dehydration process (e.g. air drying, heat treatment, etc.) took place on a meshed screen with the backside of the spent coffee grounds-infused weed barrier mat (201) contacting the meshed screen. In another embodiment of the invention, the solidified sheet of dried spent coffee-infused pulp may be suspended in air during dehydration without contacting any meshed screens, which in turn leaves no screen marks on either the frontside or the backside of the spent coffee grounds-infused weed barrier mat (201).

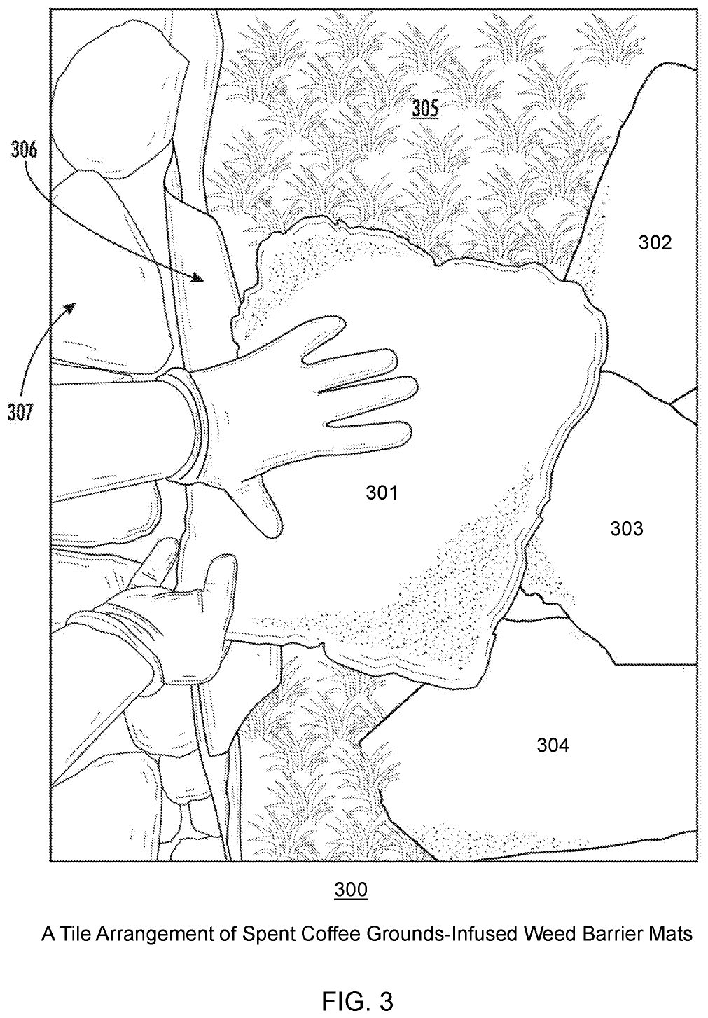

FIG. 3 shows a tile arrangement (300) of spent coffee grounds-infused weed barrier mats, in accordance with an embodiment of the invention. As illustrated in the tile arrangement (300) in FIG. 3, a plurality of spent coffee grounds-infused weed barrier mats (301, 302, 303, 304) are placed closely in a tile formation to cover a top surface layer (305), which may be a layer of grass, mulch, or topsoil in a garden. In the preferred embodiment of the invention, each spent coffee grounds-infused weed barrier mat (301, 302, 303, or 304) can be bent or torn into any shapes or dimensions during the installation by a gardening crew, and does not require separate cutting tools, such as a pair of scissors or a knife, to divide a mat into multiple pieces.

Moreover, the tile arrangement (300) of the plurality of spent coffee grounds-infused weed barrier mats (301, 302, 303, 304) provides a flexible and versatile solution for weed-inhibition needs in the garden, as each mat is thick enough to smother potential weed growths effectively and is hydro-absorbent to contain rainwater and moisture over multiple seasons. The plurality of spent coffee grounds-infused weed barrier mats (301, 302, 303, 304) can also be utilized in conjunction with a conventional landscape barrier cloth (306) and stone edgings (307), as illustrated in FIG. 3.

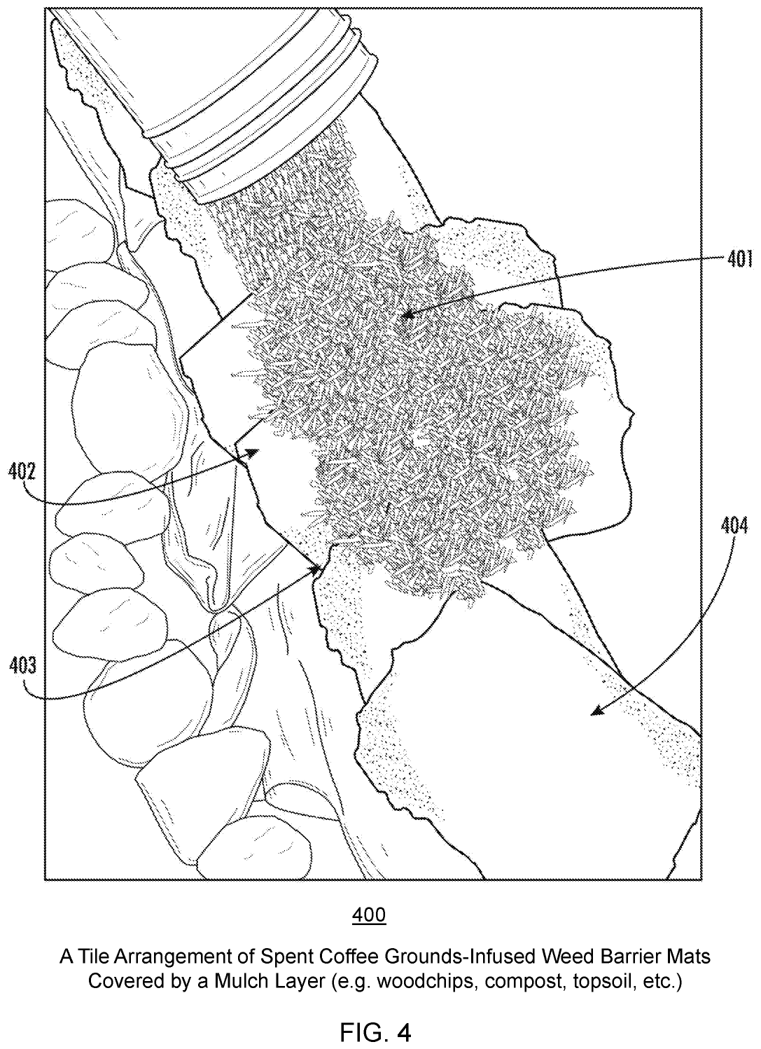

FIG. 4 shows a tile arrangement (400) of spent coffee grounds-infused weed barrier mats (402, 403, 404) covered by a mulch layer (401), in accordance with an embodiment of the invention. The mulch layer (401) is made of wooden chips, decaying leaves, straws, composts, other materials, or a combination thereof to reduce moisture evaporations, soil erosions, extreme temperature fluctuations, or weed proliferations, while promoting growths of plants, trees, or flowers that are surrounded by the mulch layer (401) in a garden.

In the preferred embodiment of the invention, the mulch layer (401) is approximately 2-inch thick on top of the tile arrangement (400) of the spent coffee grounds-infused weed barrier mats (402, 403, 404). In another embodiment, thicker or thinner layers of mulch may be utilized as deemed appropriate by a gardening crew. Compared to conventional paper-based mulch layers alone, the spent coffee grounds-infused weed barrier mats (402, 403, 404) covered by the mulch layer (401) are more durable over multiple seasons and also more absorbent of rainwater and moisture, which improve the overall aesthetics and the plant growth ecosystem of the garden.

Furthermore, the spent coffee grounds-infused weed barrier mats (402, 403, 404) also allow perennial plants to expand more easily, compared to conventional landscape cloths that frequently trap the perennial plants under the firm edges. Moreover, the spent coffee grounds-infused weed barrier mats (402, 403, 404) do not disturb a symbiotic ecosystem between plants and plant-benefitting insects (e.g. worms) in the garden, while also providing a beneficial source of nitrogen to the topsoil as the spent coffee grounds decompose.

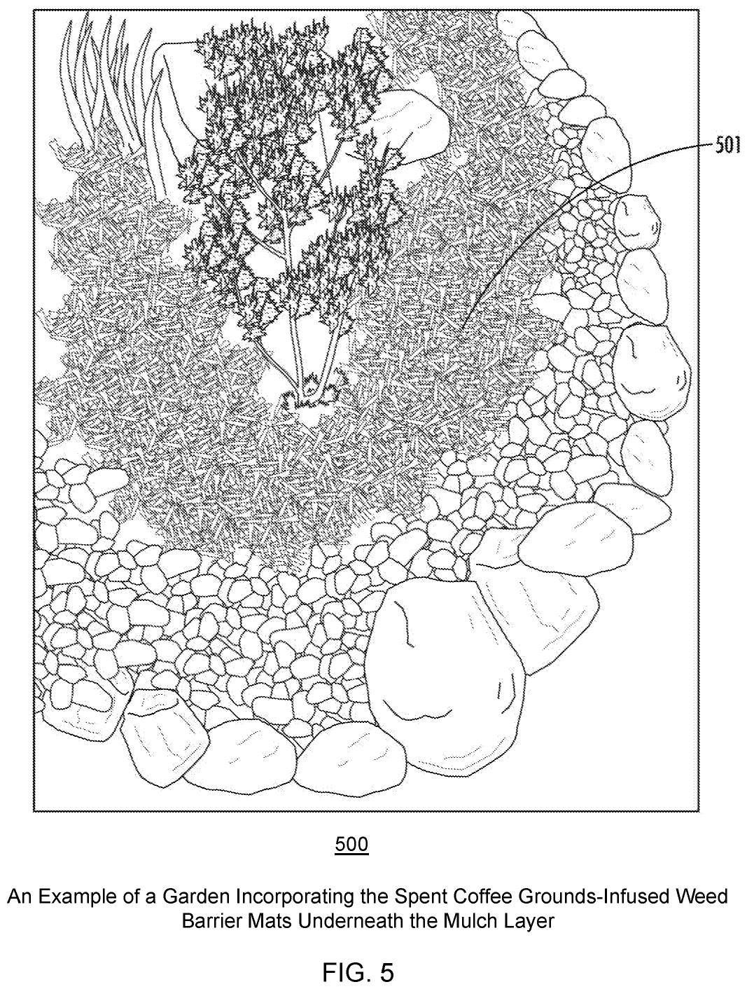

FIG. 5 shows an example (500) of a garden incorporating the spent coffee grounds-infused weed barrier mats underneath the mulch layer (501), in accordance with an embodiment of the invention. The installation of the spent coffee grounds-infused weed barrier mats underneath the mulch layer (501) protect and promote the garden's aesthetics, soil quality, and symbiotic plant- and worm ecosystem, while acting as an effective smothering barrier against weed growth. Furthermore, the spent coffee grounds-infused weed barrier mats utilize inexpensive recycled materials and compounds as environmentally-friendly and cost effective feedstocks, which are ideally suited for large-scale production.

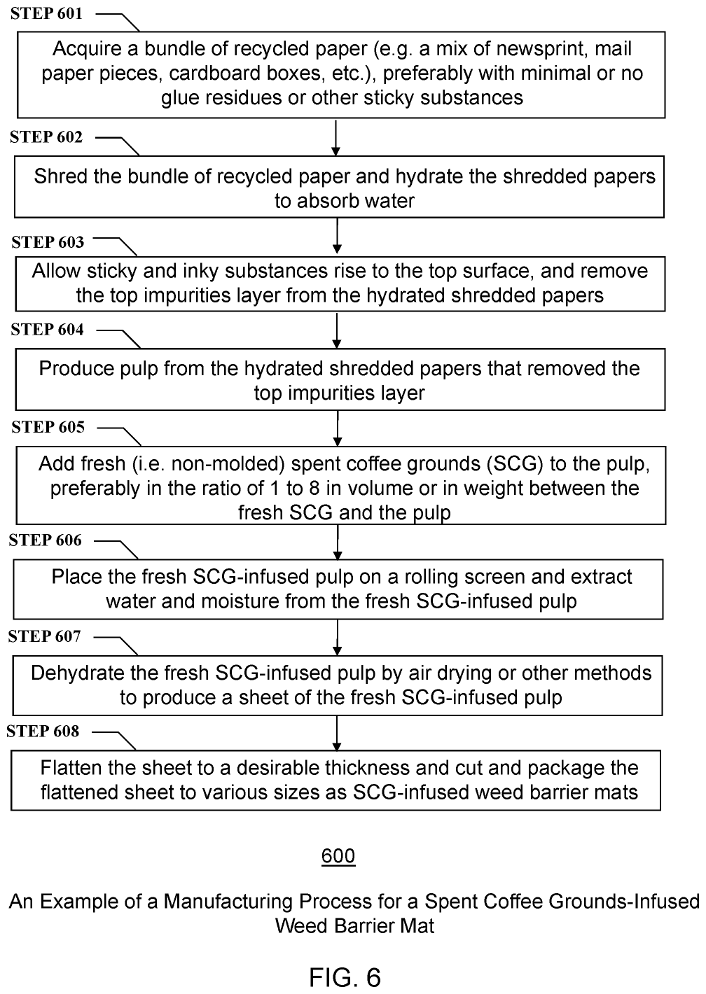

FIG. 6 shows an example of a manufacturing process (600) for a spent coffee grounds-infused weed barrier mat, in accordance with an embodiment of the invention. In this example, the first step in the manufacturing process (600) involves acquiring a bundle of recycled papers (e.g. a mix of newsprint, mail paper pieces, cardboard boxes, etc.), preferably with minimal or no glue residues or other sticky substances, as shown in STEP 601.

Then, the manufacturing process (600) involves shredding the bundle of recycled papers and hydrating the shredded papers to absorb water, as shown in STEP 602. The hydration of the shredded papers, in conjunction with mechanical agitations, allow sticky and inky substances rise to the top surface, after which the top impurities layer from the hydrated shredded papers can be removed, as shown in STEP 603. When the wetted and shredded papers undergo continued hydrations and optional mechanical agitations after removing the top impurities layer, a pulp comprising various liquified cellulose is formed, as shown in STEP 604.

Subsequently, the manufacturing process (600) adds fresh (i.e. ideally, non-molded) spent coffee grounds (SCG) to the pulp, as shown in STEP 605. In some embodiments of the invention, finely-milled coffee flours further processed from coarser SCGs are desirable as feedstock additions to the pulp for durability and maintenance of weed barrier mat-producing equipment. A preferred mixing ratio may be 1 to 8 in volume or in weight between the fresh SCG and the pulp, but other ratios may be chosen at the discretion of a chemical process engineer. After the fresh SCG is added to the pulp and mixed thoroughly, the fresh SCG-infused pulp is placed on a rolling screen, and water and moisture are extracted from the fresh SCG-infused pulp, as shown in STEP 606. The fresh SCG-infused pulp is then dehydrated by air drying or other methods to produce a sheet of the fresh SCG-infused pulp, as shown in STEP 607. Lastly, the sheet is compressed or flattened to a desirable thickness and cut and packaged into various sizes as SCG-infused weed barrier mats, as shown in STEP 608.

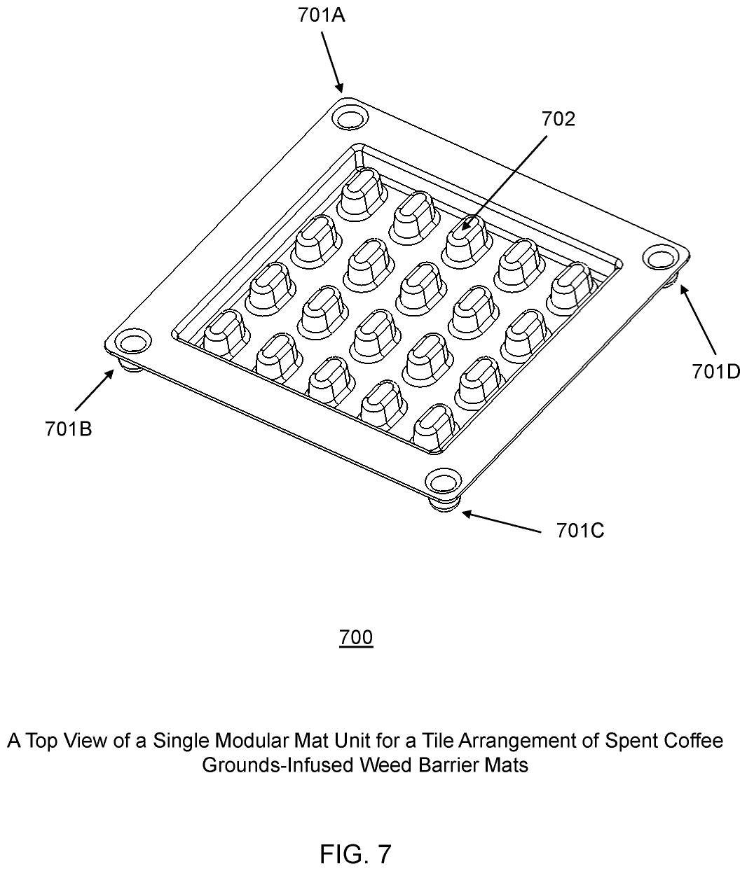

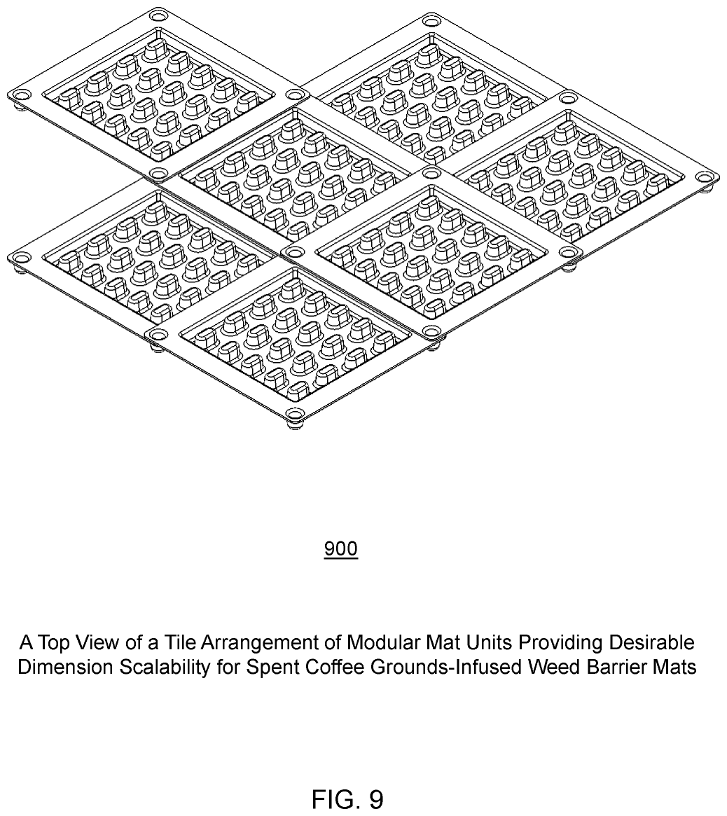

FIG. 7 shows a top view of a single modular mat unit (700) for a tile arrangement of spent coffee grounds-infused weed barrier mats, in accordance with an embodiment of the invention. As shown in this illustration, the single modular mat unit (700) may incorporate a plurality of nodules (702) that strengthen the overall modular unit structure while also holding moisture and/or rainwater to improve durability and effectiveness of the spent coffee grounds-infused weed barrier mats. Furthermore, the single modular mat unit (700) also incorporates a plurality of adjacent module docking notches (701A, 701B, 701C, 701D), which are configured to dock with other modular mat units to form a user-desired scalable dimension of the spent coffee grounds-infused weed barrier mats in a tile formation, as shown in FIG. 3 and FIG. 9.

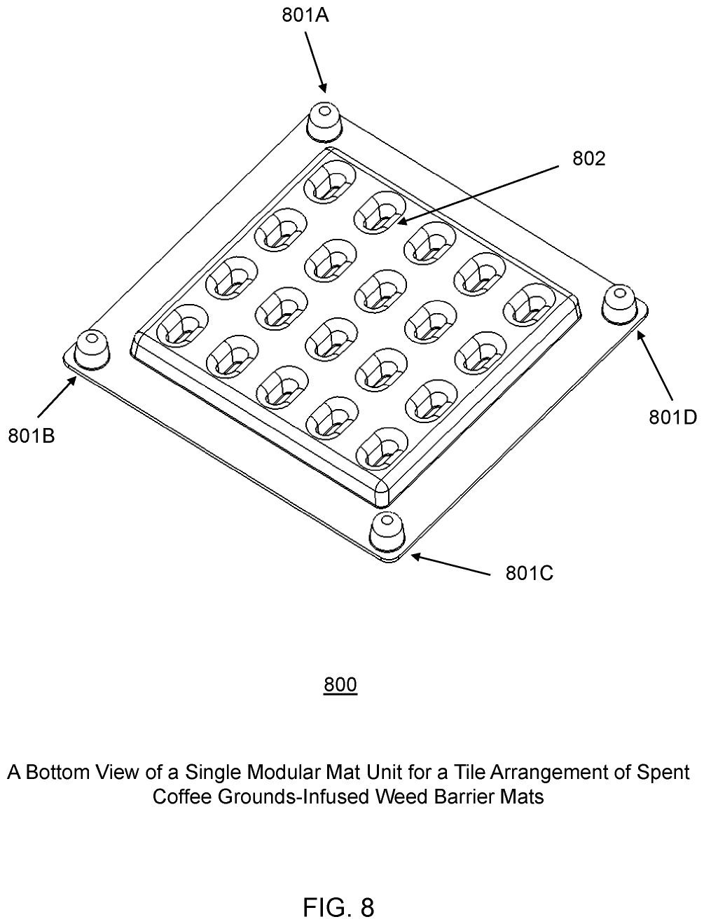

FIG. 8 shows a bottom view of a single modular mat unit (800) for a tile arrangement of spent coffee grounds-infused weed barrier mats, in accordance with an embodiment of the invention. As shown in this illustration, the single modular mat unit (800) may incorporate a plurality of nodules (802) that strengthen the overall modular unit structure while also holding moisture and/or rainwater to improve durability and effectiveness of the spent coffee grounds-infused weed barrier mats. Furthermore, the single modular mat unit (800) also incorporates a plurality of adjacent module docking notches (801A, 801B, 801C, 801D), which are configured to dock with other modular mat units to form a user-desired scalable dimension of the spent coffee grounds-infused weed barrier mats in a tile formation, as shown in FIG. 3 and FIG. 9.

FIG. 9 shows a top view of a tile arrangement (900) of modular mat units providing desirable dimension scalability for spent coffee grounds-infused weed barrier mats, in accordance with an embodiment of the invention. As shown in this tile arrangement (900), modular mat units can be attached to each other by docking into adjacent module docking notches. The scalable attachment of modular mat units effectively provides a larger surface area for the spent coffee grounds-infused weed barrier mats, and the total surface size of the mats is modularly adjustable based on customer needs and requirements in a particular garden. Similarly, the modular mat units can also be detached from each other by removing or pulling adjacent module docking notches. The scalable detachment of modular mat units effectively provides a smaller surface area for the spent coffee grounds-infused weed barrier mats, and the total surface size of the mats is modularly adjustable based on customer needs and requirements in a particular garden.

Various embodiments of the invention of have been described above and also illustrated in part by FIGS. 1-9. The present invention provides several advantages over conventional methods of weed growth inhibitions using chemicals or paper mulches. One advantage of an embodiment of the present invention is providing a more durable, hydro-absorbent, and easily-divisible novel weed barrier mat incorporating spent coffee grounds to protect and promote a garden's aesthetics, soil quality, and ecosystem, while acting as an effective smothering barrier against weed growth.

Another advantage of an embodiment of the present invention is providing an environmentally-friendly and cost-effective novel weed barrier mat that utilizes inexpensive recycled materials and compounds.

Yet another advantage of an embodiment of the present invention is providing a relatively simple, scalable, and cost effective method of manufacturing an environmentally-friendly and durable novel weed barrier mat that does not harm the garden's aesthetics, soil quality, and ecosystem.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the claims presented below.

What is claimed is:

1. A method for producing a spent coffee grounds (SCG)-infused modular weed barrier mat, the method comprising the steps of:
acquiring a bundle of recycled paper with minimal or no glue residues and other sticky substances;
shredding the bundle of recycled paper to produce shredded papers;
hydrating the shredded papers to absorb water to produce hydrated and shredded papers;
agitating the hydrated and shredded papers to isolate and raise sticky and inky substances to a top surface, which in turn forms a top impurities layer from the hydrated and shredded papers;
removing the top impurities layer from the hydrated and shredded papers;
producing a pulp from the hydrated and shredded papers after removing the top impurities layer;
adding non-molded spent coffee grounds (SCG) to the pulp to produce a fresh SCG-infused pulp;
placing the fresh SCG-infused pulp on a rolling screen and extracting water and moisture from the fresh SCG-infused pulp;
dehydrating the fresh SCG-infused pulp by air drying or another dehydration process to produce a sheet of the fresh SCG-infused pulp;
flattening the sheet to a desirable thickness and cut to produce a flattened sheet of the fresh SCG-infused pulp; and
packaging the flattened sheet in modularly-attachable dimensions as the SCG-infused modular weed barrier mat.

2. The method of claim 1, wherein the non-molded spent coffee grounds (SCG) are finely-milled coffee flours that are further processed from coarser SCGs for enhanced durability and maintenance of weed barrier mat-producing equipment.

3. The method of claim 1, wherein the step of flattening the sheet and the step of packaging the flattened sheet in modularly-attachable dimensions as the SCG-infused modular weed barrier mat involve forming adjacent module docking notches in corners or edges of the flattened sheet, wherein the adjacent module docking notches of the SCG-infused modular weed barrier mat are configured to dock into or detach from other adjacent module docking notches belonging to a second SCG-infused modular weed barrier mat.

4. The method of claim 1, wherein the step of flattening the sheet and the step of packaging the flattened sheet in modularly-attachable dimensions as the SCG-infused modular weed barrier mat involve forming a plurality of nodules in the flattened sheet that provides structural strength and spaces to hold moisture or rainwater in the SCG-infused modular weed barrier mat.

5. The method of claim 1, wherein the flattened sheet in modularly-attachable dimensions as the SCG-infused modular weed barrier mat constitutes a single modular mat unit, which is configured to be attached to or detached from other modular mat units to form a tiled arrangement of SCG-infused modular weed barrier mats.

6. The method of claim 5, wherein the tiled arrangement of the SCG-infused modular weed barrier mats provides a scalable sizing of an effective weed barrier mat area based on a user's particular gardening needs and requirements.

7. The method of claim 1, wherein the bundle of recycled paper includes newsprints, slick pieces of mailers, light cardboards, or other recycled cellulose materials.

8. The method of claim 1, wherein the modularly-attachable dimensions of the flattened sheet are standardized unit sizes of rectangles or squares.

9. A spent coffee grounds (SCG)-infused modular weed barrier mat comprising:
a bundle of recycled paper with minimal or no glue residues and other sticky substances, wherein the bundle of recycled paper is transformed into a pulp after shredding, hydration, and removal of a top impurities layer; and
non-molded spent coffee grounds (SCG) added to the pulp to form a fresh SCG-infused pulp, which is subsequently placed on a rolling screen, dehydrated, flattened, and cut to be transformed into a flattened sheet of the fresh SCG-infused pulp, wherein the flattened sheet is then packaged in modularly-attachable dimensions as a SCG-infused modular weed barrier mat.

10. The spent coffee grounds (SCG)-infused modular weed barrier mat of claim 9, further comprising adjacent module docking notches in corners or edges of the flattened sheet, wherein the adjacent module docking notches of the SCG-infused modular weed barrier mat are configured to dock into or detach from other adjacent module docking notches belonging to a second SCG-infused modular weed barrier mat.

11. The spent coffee grounds (SCG)-infused modular weed barrier mat of claim 9, further comprising a plurality of nodules in the flattened sheet that provides structural strength and spaces to hold moisture or rainwater in the SCG-infused modular weed barrier mat.

12. The spent coffee grounds (SCG)-infused modular weed barrier mat of claim 9, wherein the non-molded spent coffee grounds (SCG) are finely-milled coffee flours that are further processed from coarser SCGs for enhanced durability and maintenance of weed barrier mat-producing equipment.

13. The spent coffee grounds (SCG)-infused modular weed barrier mat of claim 9, wherein the SCG-infused modular weed barrier mat constitutes a single modular mat unit, which is configured to be attached to or detached from other modular mat units to form a tiled arrangement of SCG-infused modular weed barrier mats.

14. The spent coffee grounds (SCG)-infused modular weed barrier mat of claim 13, wherein the tiled arrangement of the SCG-infused modular weed barrier mats provides a scalable sizing of an effective weed barrier mat area based on a user's particular gardening needs and requirements.

15. The spent coffee grounds (SCG)-infused modular weed barrier mat of claim 9, wherein the bundle of recycled paper includes newsprints, slick pieces of mailers, light cardboards, or other recycled cellulose materials.

16. The spent coffee grounds (SCG)-infused modular weed barrier mat of claim 9, wherein the modularly-attachable dimensions of the flattened sheet are standardized unit sizes of rectangles or squares.
